(19) United States
(12) Patent Application Publication
(10) Pub. No.: US 2003/0117919 A1
(43) Pub. Date: Jun. 26, 2003

(54) Optical disk recording and reproducing apparatus and tilt adjustment method therefor

(75) Inventor: Nobuhiro Tatsuta, Ora-gun (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/322,208

(22) Filed: Dec. 18, 2002

(30) Foreign Application Priority Data
Dec. 21, 2001 (JP) 2001-389591

(51) Int. Cl. G11B 7/00

(52) U.S. Cl. 369/53.19; 369/53.35

(57) ABSTRACT

A tilt adjustment method for an optical disk recording and reproducing apparatus in which a signal is recorded on or reproduced from a disk using an optical pickup. In an optical disk recording and reproducing apparatus which uses an optical pickup having a tilt adjustment coil for adjusting the tilt of an objective lens, the errors contained in a signal reproduced from the disk are counted each time the tilt voltage to be supplied to the tilt adjustment coil is changed. When an appropriate count value is obtained, the tilt voltage at this state is determined to be an optimum tilt voltage.

### BACKGROUND OF THE INVENTION

1. Field of the Invention

The present invention relates to an optical disk recording and reproducing apparatus which is configured to record a signal on a disk using a laser emitted from an optical pickup and also to reproduce a signal recorded on the disk using the laser.

2. Description of Related Art

Disk players for reading a signal recorded on a disk using an optical pickup are in widespread use. Recently, optical disk recording and reproducing apparatuses configured to allow, in addition to signal reproduction, recording of a signal on a disk using a beam of focused laser light (a laser beam) emitted from the optical pickup have been commercialized. Further, optical disk recording and reproducing apparatuses capable of recording a signal while disk rotation is controlled at a high constant linear velocity such as a velocity which is 4, 8, 12, or 16 times higher than the normal linear recording velocity, are being developed.

In such optical disk recording and reproducing apparatuses, in which it is necessary to accurately emit a laser beam from the optical pickup in relation to a signal track on a disk surface, a focus control operation and a tracking control operation are performed. The focus control operation is performed by supplying a drive current to a focusing coil for shifting an objective lens in the direction of a disk surface and the tracking control operation is performed by supplying a drive current to a tracking coil for shifting the objective lens in the radial direction of the disk.

In recent years, in order to record a number of signals on the disk, high density signal recording is being attempted. In order to achieve high recording density, it is necessary to emit a laser beam onto a disk surface while the laser beam is in an optimum state. For this purpose, optical pickups configured to allow a correction operation of a relative angle offset between the disk and the objective lens, referred to as a tilt adjustment operation, have been developed.

### SUMMARY OF THE INVENTION

The present invention aims to provide a tilt adjustment method which may be suitably applied to an optical disk recording and reproducing apparatus which uses an optical pickup capable of such a tilt adjustment operation, and to such an apparatus.

In accordance with the present invention, in an optical disk recording and reproducing apparatus which uses an optical pickup having a tilt adjustment coil for adjusting the tilt of an objective lens, the errors contained in a signal reproduced from the disk are counted each time the tilt voltage to be applied to a tilt adjustment coil is changed, and a tilt voltage when the count value is in an appropriate range is set as an optimum tilt voltage.

### BRIEF DESCRIPTION OF THE DRAWINGS

These and other objects of the invention will be explained in the description below, in connection with the accompanying drawings, in which:

FIG. 1 is a flowchart showing a tilt adjustment method according to the present invention;

FIG. 2 is a block circuit diagram showing one embodiment of an optical disk recording and reproducing apparatus according to the present invention; and

FIG. 3 is a flowchart showing a variation of a tilt adjustment method according to the present invention.

### DETAILED DESCRIPTION OF THE PREFERRED EMBODIMENT

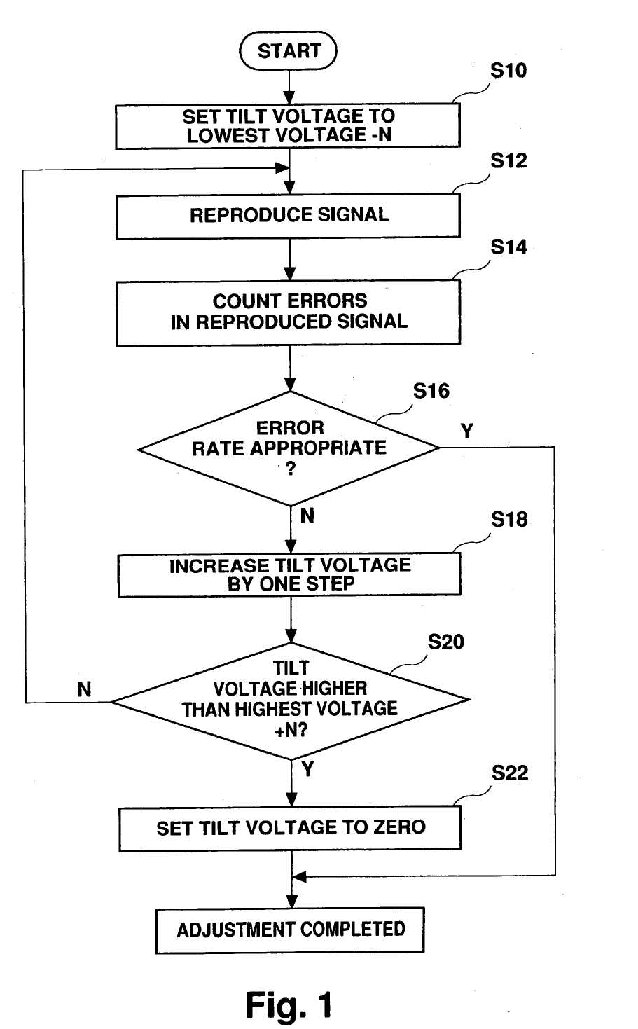

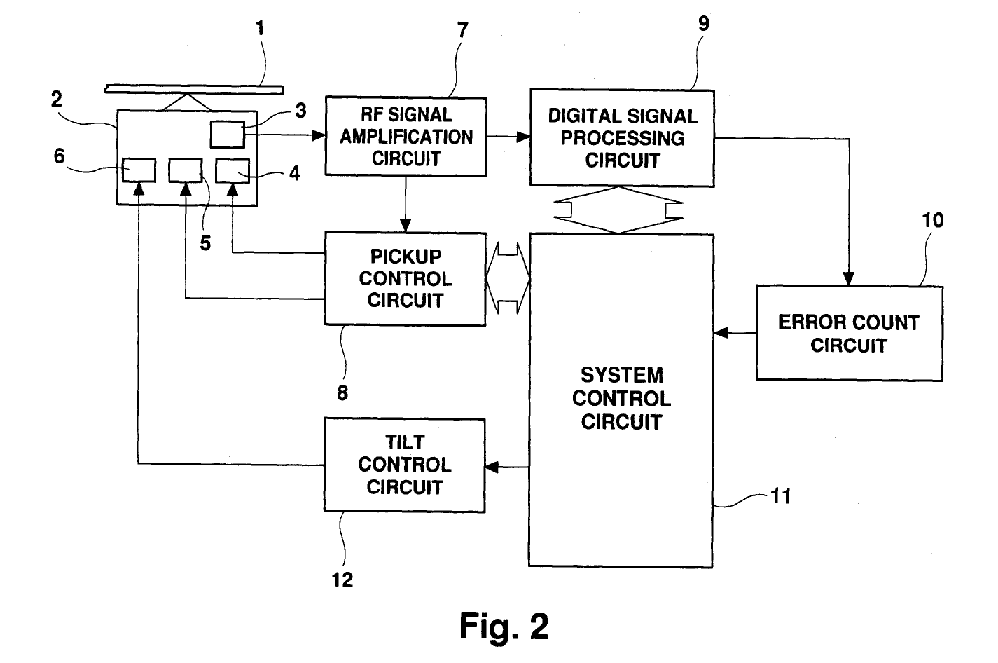

FIG. 1 is a flowchart showing a tilt adjustment method according to the present invention, and FIG. 2 is a block circuit diagram showing one embodiment of an optical disk recording and reproducing apparatus according to the present invention.

Referring first to FIG. 2, a disk 1 is mounted on a turntable (not shown) of an optical disk recording and reproducing apparatus. The disk 1 is caused to rotate by rotationally driving the turntable by means of a spindle motor (not shown). When the disk 1 is a CD-R, data concerning positional information is recorded in a wobbled pre-groove (called Wobble) on the disk, and the optical disk recording and reproducing apparatus records and reproduces a signal with regard to the disk based on a wobble signal obtained from the groove. An optical pickup 2 includes a laser diode for irradiating the disk 1 with an optical beam, a monitoring diode for monitoring the optical beam emitted by the laser diode, and a photodetector 3 for receiving the optical beam reflected from a signal surface of the disk 1. The optical pickup 2 is configured to move in the radial direction of the disk 1 by means of a pickup translating motor (not shown).

Further, the optical pickup 2 includes a focusing coil 4 for shifting an objective lens (not shown) in the direction of a disk surface, a tracking coil 5 for shifting the objective lens in the radial direction of the disk 1, and a tilt adjustment coil 6 for adjusting an angle of the objective lens with regard to the disk 1.

An RF signal amplification circuit 7 amplifies an RF signal obtained from the photodetector 3 provided in the optical pickup 2 and also shapes a signal waveform. A pickup control circuit 8 controls a focusing operation for focusing the optical beam emitted by the optical pickup 2 onto a signal surface of the disk 1 and also controls a tracking operation for causing the optical beam to track the signal track of the signal surface. The pickup control circuit 8 is configured to supply a control signal to the focusing coil 4 and the tracking coil 5.

A digital signal processing circuit 9 subjects a digital signal output from the RF signal amplification circuit 7 to signal processing and also demodulates various signals. As is common and well known, the digital signal processing circuit 7 has a function for correcting an error contained in a signal. An error count circuit 10 counts the number of errors corrected by the digital signal processing circuit 9.

A system control circuit 11 receives an input signal which is demodulated in the digital signal processing circuit 9 and also performs various control operations in response to an instruction signal output from a computer system (not shown). A tilt control circuit 12 supplies a drive voltage to the tilt adjustment coil 6 included in the optical pickup 2 based on a signal output form the system control circuit 11. The tilt control circuit 12 is configured such that a voltage to be supplied to the tilt adjustment coil 6 can be changed stepwise in (2N+1) steps from −N to +N, where N is a natural number.

The operation of an optical disk recording and reproducing apparatus of the present invention which is configured as described above will be now described.

A tilt adjustment operation is performed by reproducing a signal recorded on the disk. When a control operation for reproducing a signal recorded on the disk 1 is started, the pickup control circuit 8 supplies a focus control signal and a tracking control signal to the focusing coil 4 and the tracking coil 5, respectively, which are included in the optical pickup 2, and a known control operation is performed.

Under such a control operation, a laser beam reflected off of the signal surface of the disk 1 strikes the photodetector 3. Consequently, an RF signal obtained from the photodetector 3 is supplied to the RF signal amplification circuit 7 where the input signal is amplified and shaped in a digital signal waveform. The digital signal obtained in the RF signal amplification circuit 7 is then input to the digital signal processing circuit 9 for demodulation and error correction.

The number of errors corrected by the digital signal processing circuit 9 is counted by the error count circuit 10 every predetermined number of blocks or in predetermined units, such as every second. The count value provided by the error count circuit 10 is supplied to the system control circuit 11.

The error count operation is performed in a manner such as described above. Next, the tilt adjustment method according to the present invention will be described with reference to the flowchart shown in FIG. 1. The tilt adjustment method illustrated in FIG. 1 is performed in response to a recording or reproduction operation instruction provided to the system control circuit from a master device such as a computer, before either signal recording onto the disk or signal reproduction from the disk is performed.

The tilt adjustment operation according to the present invention begins with the setting of a tilt voltage to be supplied to the tilt adjustment coil 6 from the tilt control circuit 12 to −N level which corresponds to the lowest voltage (step S10). Application of the tilt voltage −N to the tilt adjustment coil 6 causes the objective lens to be tilted by the largest angle in one direction. In such a state, a signal recorded on the disk 1 is reproduced (step S12). Although theoretically a signal recorded on any part of the disk 1 may be reproduced, because effects of abnormal tilt are more obvious along the outer periphery of the disk 1, tilt adjustment can be preferably performed using a signal recoded on portions of the disk closer to the outer periphery.

When the reproduction operation is performed as described above, the digital signal processing circuit 9 performs error correction and the error count circuit 10 counts the errors corrected by the error correction (step S14). The number of errors counted by the error count circuit 10 is supplied to the system control circuit 11, which determines whether or not the number is an appropriate value, namely a value within an appropriate range suitable for reproduction and recording (step S16).

If it is determined that the number of errors is inappropriate (the number of errors is not an appropriate value) in step S16, the tilt voltage to be supplied to the tilt adjustment coil 6 is increased by one level from the level −N (step S18). It is then determined whether or not the increased tilt voltage is higher than the highest voltage +N (step S20).

When it is determined that the tilt voltage is not higher than the highest voltage +N, the process returns to step S12, and each step described above is repeated. When, as these step are repeated, an appropriate value for the number of error is found at step S16, it is then determined that the tilt voltage obtained at this state is suitable for reproduction, and the tilt adjustment operation is completed. Further, when the tilt voltage is determined to be higher than the highest voltage +N in step S20, the tilt voltage is set to 0 which is an intermediate voltage between the lowest voltage −N and the highest voltage +N (step S22), and then the tilt adjustment operation is completed.

The objective lens is configured such that the tilt of the lens is neutral, namely the lens is not tilted with regard to the main body of the optical pickup 2, when the tilt voltage is set to 0. In this state, although the number of errors contained in a reproduced signal falls outside of the appropriate range, in the absence of any specific problematic results, reproduction or recording will be performed. If, on the other hand, it is determined that reproduction or recording cannot be performed without problem, an error handling routine is performed while start of recording or reproduction is temporarily prohibited. Such a control operation can be performed by setting a threshold value used for determining whether or not the number of errors is an appropriate value in step S16 to a value necessary for a normal recording or reproduction operation. Specifically, in a case where the threshold value is set to the upper limit for the error rate allowing the normal reproducing and/or recording operation, when it is determined in step S16 that the number of errors counted in step S14 is not an appropriate value, such a state is treated as an error. On the other hand, in a case where the threshold value is set to a value in a predetermined allowable range, which is smaller than the above-mentioned upper limit number of errors, a control operation which allows the reproduction or recording operation can be performed even when it is determined in step 16 that the number of errors is not an appropriate value, as long as the error rate does not exceed the upper limit.

The value in an allowable range may be, for example, the upper limit number of errors in a range which allows disk recording or disk reproducing with preferable quality. The upper error limit which enables the apparatus to operate normally and the upper error limit of acceptable quality may be obtained in advance through experiment or other means.

As described above, the apparatus of the present invention is configured to count the number of errors contained in a reproduced signal which has been read from the disk 1. When a signal is already recorded on the disk (for example, the disk 1 is a read-only disk or a recordable disk to which data recording is already performed), the signal thus recorded on the disk 1 can be reproduced and used as a reproduced signal. When a recordable disk is used as the disk 1, it is possible to use a wobble signal which is reproduced from the pre-groove formed in the disk. Because such a wobble signal can be read from a blank disk, specifically from a recordable disk on which no data signal is not recorded, tilt adjustment can be performed even for a blank disk.

Although, unlike a data signal recorded on the disk, a wobble signal cannot be used for error correction, because a wobble signal contains time information in a form of a sub code which is represented in a CRC (Cyclic Redundancy Code), error detection can be performed on the reproduced sub code of the wobble signal using Cyclic Redundancy Check. Therefore, by providing the digital signal processing circuit 9 with a mechanism which performs Cyclic Redundancy Check on the sub code of the wobble signal to count the detected number of errors, the number of errors in the wobble signal can be counted.

It is preferable that a separate threshold value for use in the determination step S16 be provided for use when counting the errors in a data signal recorded and for counting the errors in a wobble signal.

It is also preferable that the threshold value used for the determination step S16 be variable in accordance with disk type, reproduction speed, recording speed, and the like. In addition to a rough classification of disk types, such as into read-only and recordable disks, recordable disks can further be classified into more specific types according to manufacturer, type dye, highest recording rate, and so on. Such disk classification can be recognized by reading a disk discrimination code recorded on the disk itself.

In order to switch the threshold value in accordance with disk type or the like as described above, a table storing an appropriate threshold value corresponding to each combination of disk type and reproduction speed and each combination of disk type and the recording speed may be prepared and stored in a memory within the system control circuit 11, or in a storage device which is accessible by the system control circuit 11. In general, the higher the recording or reproduction speed, the greater the threshold value. The threshold value corresponding to each combination may be obtained in advance through experiment or the like and registered in the table noted above.

In such a case, the system control circuit 11 may search the table for a threshold value corresponding to a combination of the disk type recognized by the disk discrimination code read from the disk and the recording or reproducing speed instructed to the system control circuit 11 by a master device such as a host computer, and perform the tilt adjustment operation shown in FIG. 1 using the threshold value thus searched. As a result of such a processing, accurate tilt adjustment can be performed in accordance with varied conditions.

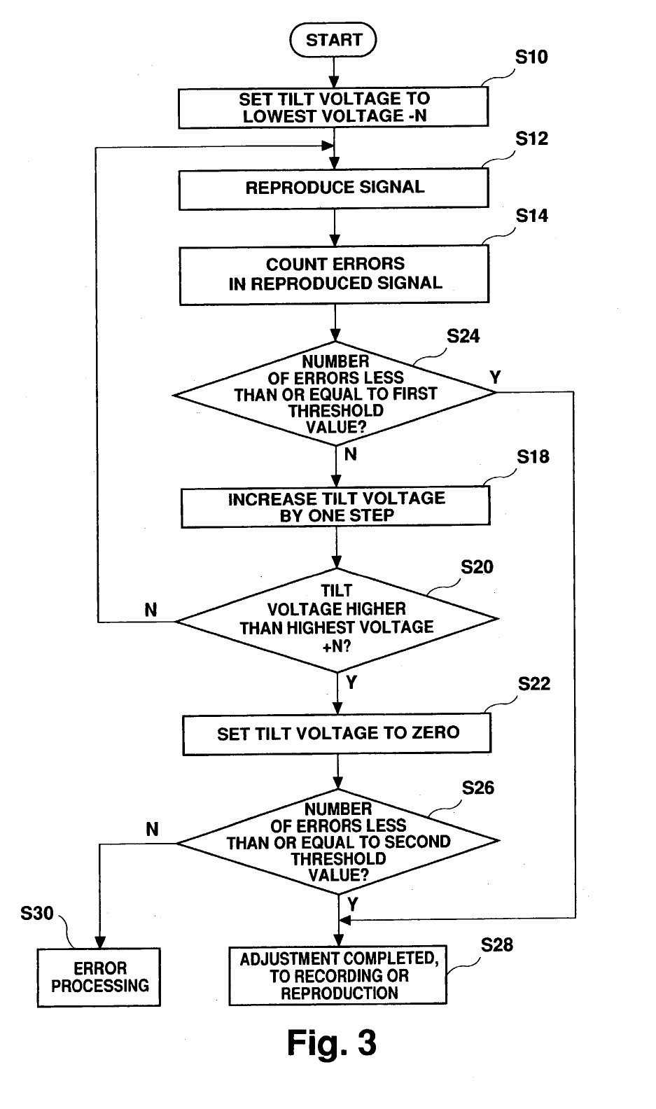

Alternatively, the tilt adjustment procedures shown in FIG. 3 can also be performed. The process steps in FIG. 3 that are similar to those in FIG. 1 are denoted with the same numerals and their description will not be repeated.

In the variation shown in FIG. 3, in determination concerning the number of errors contained in a reproduced signal of the disk, first and second threshold values are used. The second threshold value may be the above-described upper limit number of errors which allows normal operation of the disk recording and reproducing apparatus. The first threshold value should be smaller than the second threshold value, and may be, for example, the upper limit number of errors which allows disk recording or reproduction with preferable quality.

In the process shown in FIG. 3, after the number of errors in a signal reproduced from the disk is counted in step S14, it is determined whether or not the number of errors is equal to or less than the first threshold value (step S24). If the number of errors is equal to or smaller than the threshold value, the tilt adjustment is completed and recording on or reproduction from the disk will be started (step S28). If, on the other hand, it is determined that the number of errors is greater than the first threshold value, the tilt voltage is increased by one level (step S18), and then processes similar to those shown in FIG. 1 will be performed. When it is determined in step S20 that the tilt voltage is higher than the highest voltage +N, the tilt voltage is set to 0 (step S22), and then it is determined whether or not the number of errors is equal to or less than the second threshold value (step S26). As a result of this determination, when the number of errors is equal to or less than the second threshold value, it is determined that even though the number of errors is high, the disk recording and reproducing apparatus can perform normal recording or reproducing operation without any serious problems resulting. Therefore, the tilt adjustment is completed and the process shifts to recording or reproducing with regard to the disk (step S28). On the other hand, if it is determined in step S26 that the number of errors is greater than the second threshold value, it is determined that the error rate is too high for the disk recording and reproducing apparatus to record or reproduce normally and that therefore an operation error exists. Error processing such as notification of error generation to a computer or the like is then performed (step S30).

Although in the examples in FIGS. 1 and 3, the tilt adjustment is performed by increasing the tilt voltage from the lowest to the highest voltage, it is also possible that the tilt adjustment may be performed by decreasing the tilt voltage from the highest to the lowest voltage. Further, in the example of FIG. 1, when an acceptable error rate cannot be obtained despite application of all selectable tilt voltages, the tilt voltage is set to an intermediate value between the lowest and the highest voltages. Alternatively, in such a case, the tilt voltage can also be set to the voltage which resulted in the smallest error rate during tilt adjustment.

According to the present invention, in an optical disk recording and reproducing apparatus using an optical pickup having a tilt adjustment coil for adjusting a tilt of an objective lens, the errors in a signal reproduced from the disk is counted each time a tilt voltage to be supplied to the tilt adjustment coil is changed and, when the count value is an appropriate value, the tilt voltage at this state is set as an appropriate tilt voltage. It is therefore possible to accurately project a laser beam emitted from the optical pickup onto a signal surface of the disk.

Further, because a wobble signal can be used as a reproduced signal for tilt adjustment according to the present invention, tilt adjustment can be performed even when a blank disk with no signals recorded thereon is used.

In accordance with a certain aspect of the present invention, because the threshold value used for determination concerning the number of errors is variable depending on the disk type, the present invention shows a significant advantage when implemented in an optical disk recording and reproducing apparatus capable of using disks having different characteristics and standards.

Further, in accordance with another aspect of the present invention, because the threshold value used for determination concerning the number of errors is variable depending on the recording or reproducing speed of the disk, tilt adjustment suitable for the recording or reproduction operation at each speed can be performed.

In accordance with still another aspect of the present invention, the tilt voltage is varied from the lowest to the highest voltage, or from the highest to the lowest voltage, so that tilt adjustment can be performed quickly.

In accordance with a further aspect of the present invention in which the tilt voltage is set to an intermediate value between the highest and lowest voltages when the count value obtained from the number of errors is not an appropriate value, by determining the lowest and highest voltages such that the intermediate value becomes zero, no voltage is applied to the tilt adjustment coil when the tilt voltage is set to 0. Accordingly, the tilt adjustment will not adversely affect the operation of the objective lens, which is advantageous when the subsequent control operation such as an error processing is performed.

In accordance with a still further aspect of the present invention in which, when none of the measured the error rates is an appropriate value, the tilt voltage is set to the voltage at which the least number of errors is detected, the tilt can be adjusted to a state most appropriate to the situation at that time.

While the preferred embodiment of the present invention has been described using specific terms, such description is for illustrative purposes only, and it is to be understood that changes and variations may be made without departing from the spirit or scope of the appended claims.

What is claimed is:

1. An optical disk recording and reproducing apparatus comprising:
an optical pickup including a tilt adjustment coil for adjusting a tilt of an objective lens;
an error count circuit for counting the errors contained in a predetermined signal read from a disk by the optical pickup; and
a control circuit for causing the optical pickup to read a signal from the disk and determining whether or not the number of errors in the read signal counted by the error count circuit during a unit of time satisfies a predetermined condition,
wherein when the number of errors does not satisfy the predetermined condition, the control circuit changes a tilt voltage to be supplied to the tilt adjustment coil according to a rule and then again causes the optical pickup to read a signal from the disk for repeating the determination, and
when the number of errors satisfies the predetermined condition, the control circuit sets the tilt voltage employed at that time as a tilt voltage for use when recording or reproducing a signal on or from the disk.

2. An optical disk recording and reproducing apparatus according to claim 1, wherein
a recording signal recorded on the disk is read and used as the predetermined signal read from the disk.

3. An optical disk recording and reproducing apparatus according to claim 1, wherein
when the disk is a recordable disk, a wobble signal obtained from a pre-groove of the disk is read and used as the predetermined signal read from the disk.

4. An optical disk recording and reproducing apparatus according to claim 1, wherein
the predetermined condition used for the determination is selected in accordance with a characteristic of the disk from among a plurality of predetermined conditions.

5. An optical disk recording and reproducing apparatus according to claim 1, wherein
the predetermined condition used for the determination is selected in accordance with a recording or reproducing speed associated with the disk from among a plurality of predetermined conditions.

6. An optical disk recording and reproducing apparatus according to claim 1, wherein
the rule for changing the tilt voltage when the number of errors does not satisfy the predetermined condition requires that the tilt voltage be changed in steps from a predetermined first limit voltage to a predetermined second limit voltage.

7. An optical disk recording and reproducing apparatus according to claim 6, wherein
when the number of errors does not satisfy the predetermined condition even when the tilt voltage is changed up to the second limit voltage, the control circuit sets an intermediate value between the first limit voltage and the second limit voltage as the tilt voltage for use in recording or reproducing a signal on or from the disk.

8. An optical disk recording and reproducing apparatus according to claim 6, wherein
for each step to which the control circuit changes the tilt voltage from the first limit voltage to the second limit voltage according to the rule, the control circuit stores the number of errors counted by the error count circuit, and
when no tilt voltage at which the number of errors satisfies the predetermined condition is found even when the tilt voltage is varied up to the second limit voltage, the control circuit sets the voltage corresponding to the smallest value for the number of errors among the stored values as the tilt voltage for use in recording or reproducing a signal on or from the disk.

9. An optical disk recording and reproducing apparatus according to claim 6, wherein
when no tilt voltage at which the number of errors satisfies the predetermined condition is found even when the tilt voltage is varied up to the second limit voltage, the control circuit determines whether or not the number of errors satisfies a normal operation condition and executes an error processing when it is determined that the number of errors does not satisfy the normal operation condition.

10. A tilt adjustment method in an optical disk recording and reproducing apparatus comprising an optical pickup including a tilt adjustment coil for adjusting a tilt of an objective lens, the method comprising the steps of:
counting the errors in a predetermined signal which has been read from a disk by the optical pickup;
determining whether or not the number of errors counted in the read signal satisfies a predetermined condition;
when the number of errors does not satisfy the predetermined condition, changing a tilt voltage to be supplied to the tilt adjustment coil according to a predetermined rule and then causing the optical pickup to again read a signal from the disk in order to repeat the determination; and
when the number of errors satisfies the predetermined condition, setting the associated tilt voltage as the tilt voltage for use in recording or reproducing a signal on or from the disk.

11. A tilt adjustment method according to claim 10, wherein
a recording signal recorded on the disk is read and used as the predetermined signal read from the disk.

12. A tilt adjustment method according to claim 10, wherein
when the disk is a recordable disk, a wobble signal obtained from a pre-groove of the disk is read and used as the predetermined signal read from the disk.

13. A tilt adjustment method according to claim 10, wherein
the predetermined condition used for the determination is selected in accordance with a characteristic of the disk from among a plurality of predetermined conditions.

14. A tilt adjustment method according to claim 10, wherein
the predetermined condition used for the determination is selected in accordance with a recording or reproducing speed associated with the disk from among a plurality of predetermined conditions.

15. A tilt adjustment method according to claim 10, wherein
the rule for changing the tilt voltage when the number of errors does not satisfy the predetermined condition requires that the tilt voltage be changed in steps from a predetermined first limit voltage to a predetermined second limit voltage.

16. A tilt adjustment method according to claim 15, further comprising the step of:
when no tilt voltage at which the number of errors satisfies the predetermined condition is found even when the tilt voltage is varied up to the second limit voltage, setting an intermediate value between the first limit voltage and the second limit voltage as the tilt voltage for use in recording or reproducing a signal on or from the disk.

17. A tilt adjustment method according to claim 15, further comprising the steps of:
for each step to which the control circuit changes the tilt voltage from the first limit voltage to the second limit voltage according to the rule, the control circuit stores the number of errors counted by the error count circuit, and
when no tilt voltage at which the number of errors satisfies the predetermined condition is found even when the tilt voltage is varied up to the second limit voltage, the control circuit sets the voltage corresponding to the smallest value for the number of errors among the stored values as the tilt voltage for use in recording or reproducing a signal on or from the disk.

18. A tilt adjustment method according to claim 15, further comprising the steps of:
when no tilt voltage at which the number of errors satisfies the predetermined condition is found even when the tilt voltage is varied up to the second limit voltage, determining whether or not the number of errors satisfies a normal operation condition, and
executing a predetermined error processing when the number of errors is determined not to satisfy the normal operation condition.
